(19) United States
(12) Patent Application Publication
(10) Pub. No.: US 2017/0176645 A1
(43) Pub. Date: Jun. 22, 2017

(54) SPECTACLE LENS

(71) Applicants: AKIHIRO MAEDA, Shinjuku-ku (JP); HOYA LENS THAILAND LTD., Patumthani (TH)

(72) Inventor: Akihiro MAEDA, Shinjuku-ku (JP)

(21) Appl. No.: 15/306,453

(22) PCT Filed: Apr. 24, 2015
(86) PCT No.: PCT/JP2015/062599

§ 371 Date: Oct. 24, 2016

(30) Foreign Application Priority Data
Apr. 24, 2014 (JP) 2014-090739

(51) Int. Cl. G02B 1/14; G02C 7/02; B05D 1/18; G02B 1/115; B05D 1/00; B05D 1/02

(52) U.S. Cl. CPC G02B 1/14; B05D 1/005; B05D 1/02; B05D 1/18; G02B 1/115; G02C 7/02

(57) ABSTRACT

A spectacle lens which exhibits excellent abrasion resistance. The spectacle lens includes a lens substrate and a hard coat layer having a film thickness of 5 μm or more and 100 μm or less and has an indentation hardness of the hard coat layer of 25 mgf/μm² or more and 100 mgf/μm² or less at 30 mgf load.

### TECHNICAL FIELD

The present disclosure relates to a spectacle lens having a hard coat layer.

### BACKGROUND ART

Spectacle lenses are required to have various properties. Abrasion resistance, the property to be hardly scratched as a user uses the spectacle lens in daily life, is required. Surface films such as a hard coat film and an antireflection film (AR film) are formed on the surface of a spectacle lens in consideration of abrasion resistance. The evaluation on abrasion resistance is carried out for selection of the spectacle lens substrate or the surface film in the development stage of the spectacle lens or for quality control in the manufacturing process of the spectacle lens.

There are a variety of causes for the scratches formed in actual status of use, and it has not been necessarily able to cope with scratches of the spectacle lens formed in actual use only by the testing methods of the related art.

In Patent Literature 1, a spectacle lens which has a surface film and a substrate and is characterized in that the tip bulge starting load (W_{I}) determined by the testing method using a diamond stylus is 60 g or more is disclosed as a spectacle lens exhibiting high abrasion resistance with respect to the scratches as formed when the spectacle lens is rubbed with a wood or a metal or hit by a pebble in actual use.

### CITATION LIST

### Patent Literature

Patent Literature 1: JP 2013-205777 A

### SUMMARY

### Technical Problem

According to the spectacle lens described in Patent Literature 1, although it is possible to enhance the scratch resistance to be evaluated by film peeling off load value in the diamond scratch test, there is room for improvement in abrasion resistance to be evaluated by the Bayer test and the like.

Accordingly, an embodiment of the disclosure provides a spectacle lens which exhibits excellent abrasion resistance.

### Solution to Problem

The disclosure relates to the following spectacle lens.

[1] A spectacle lens including a lens substrate and a hard coat layer having a film thickness of 5 μm or more and 100 μm or less, in which an indentation hardness of the hard coat layer at 30 mgf load is 25 mgf/μm² or more and 100 mgf/μm² or less.

[2] The spectacle lens according to [1], in which a film thickness of the hard coat layer is 7 μm or more and 100 μm or less.

[3] The spectacle lens according to [1] or [2], in which an indentation hardness of the hard coat layer at 5000 mgf load is 30 mgf/μm² or more and 100 mgf/μm² or less.

[4] The spectacle lens according to anyone of [1] to [3], in which a difference (IH₃₀−IH₅₀₀₀) between an indentation hardness IH₅₀₀₀ at 5000 mgf load and an indentation hardness IH₃₀ at 30 mgf load of the hard coat layer is 3 mgf/μm² or more.

[5] The spectacle lens according to anyone of [1] to [4], in which the hard coat layer is obtained by curing a curable composition containing inorganic oxide particles and a silicon compound having a hydrolyzable group.

[6] The spectacle lens according to [5], in which the curable composition further contains a polyfunctional epoxy compound.

[7] The spectacle lens according to anyone of [1] to [6], further including a primer layer between the lens substrate and the hard coat layer.

[8] The spectacle lens according to anyone of [1] to [7], further including an interference fringe suppressing layer between the lens substrate and the hard coat layer.

[9] The spectacle lens according to anyone of [1] to [8], further including an antireflection layer on the hard coat layer.

### Advantageous Effects

According to the present disclosure, it is possible to provide a spectacle lens which exhibits excellent abrasion resistance.

### DESCRIPTION OF EMBODIMENTS

The spectacle lens of the present disclosure includes a lens substrate and a hard coat layer having a film thickness of 5 μm or more and 100 μm or less and has an indentation hardness (hereinafter, also simply referred to as the “IH₃₀”) of the hard coat layer of 25 mgf/μm² or more and 100 mgf/μm² or less at 30 mgf load. The spectacle lens of the present disclosure exhibits excellent abrasion resistance. In addition, the spectacle lens of the present disclosure exhibits excellent crack resistance while exhibiting excellent scratch resistance and excellent abrasion resistance.

A spectacle lens having a high film peeling off load value is obtained as the film thickness of the hard coat layer is 5 μm or more and 100 μm or less. In addition, the film thickness of the hard coat layer may be 7 μm or more, 15 μm or more, or 18 μm or more from the viewpoint of obtaining a spectacle lens exhibiting a high film peeling off load value. The film thickness may be 80 μm or less, 60 μm or less, or 40 μm or less from the viewpoint of ease of manufacture. The “film thickness” means an average film thickness, and the measuring method thereof is described in Examples.

It is possible to obtain excellent abrasion resistance as the IH₃₀ of the hard coat layer of the spectacle lens of the present disclosure is 25 mgf/μm² or more and 100 mgf/μm² or less.

The IH₃₀ may be 30 mgf/μm² or more, 40 mgf/μm² or more, 55 mgf/μm² or more, 58 mgf/μm² or more, or 80 mgf/μm² or less from the viewpoint of enhancing the abrasion resistance.

The term “indentation hardness” is a value measured in conformity with the International Standard ISO 14577 by using a nano-indenter apparatus. Incidentally, the “indentation hardness” means the measured value for at least one surface provided with a hard coat layer.

The indentation hardness (hereinafter, also simply referred to as the “IH₅₀₀₀”) of the hard coat layer of the spectacle lens at 5000 mgf load may be 30 mgf/μm² or more, 40 mgf/μm² or more, or 50 mgf/μm² or more from the viewpoint of obtaining high abrasion resistance, and it may be 100 mgf/μm² or less, 80 mgf/μm² or less, 70 mgf/μm² or less, 65 mgf/μm² or less, or 63 mgf/μm² or less from the viewpoint of obtaining high crack resistance.

The difference (IH₃₀−IH₅₀₀₀) between the IH₃₀ and the IH₅₀₀₀ of the hard coat layer of the spectacle lens of the present disclosure may be 3 mgf/μm² or more, 5 mgf/μm² or more, 10 mgf/μm² or 30 mgf/μm² or less from the viewpoint of enhancing the crack resistance.

With regard to the indentation hardness IH₃₀ and IH₅₀₀₀, it is possible to obtain a hard coat layer having an indentation hardness in the above range by adjusting the composition of the hard coat layer.

Hereinafter, the configuration of the spectacle lens of the present disclosure will be described in detail.

(Lens Substrate)

With regard to the lens substrate, examples of the material to be usually used in the lens substrate of a spectacle lens may include plastics such as a polyurethane-based material (for example, polyurethane, polyurethane urea, polythiourethane), polycarbonate, and diethylene glycol-bis-allyl-carbonate and inorganic glass. The thickness and diameter of the lens substrate are not particularly limited. Usually, the thickness is about from 1 to 30 mm and the diameter is about from 50 to 100 mm. In a case in which the spectacle lens is for vision correction, it is usual to use those having a refractive index ne of about from 1.5 to 1.8 as the lens substrate. Colorless ones are usually used as the lens substrate, but it is also possible to use colored ones as long as the transparency is not impaired. In addition, the surface shape of the substrate on which a cured film is formed is not particularly limited, and it can be an arbitrary shape such as a flat shape, a convex shape, or a concave shape.

[Functional Layer]

In the spectacle lens of the present disclosure, the lens substrate is provided with at least a hard coat layer. Examples of other functional layers provided on the lens substrate may include a primer layer, an interference fringe suppressing layer, a polarizing layer, and a photochromic layer. In addition, it is also possible to further provide functional layers such as an antireflection film, a water repellent film, an ultraviolet absorbing film, an infrared absorbing film, a photochromic film, and an antistatic film on the hard coat layer if necessary. With regard to functional layers other than these, known techniques related to spectacle lenses can be applied.

The hard coat layer may be directly formed on the lens substrate surface, or it may be indirectly formed thereon via one or more other functional layers.

The spectacle lens of the present disclosure includes a lens substrate, a primer layer provided on the lens substrate, and a hard coat layer provided on the primer layer, and it may include a lens substrate, an interference fringe suppressing layer provided on the lens substrate, a primer layer provided on the interference fringe suppressing layer, and a hard coat layer provided on the primer layer.

(Hard Coat Layer)

The hard coat layer is obtained, for example, by curing a curable composition containing inorganic oxide particles (hereinafter, referred to as the “component (A)”) and a silicon compound (hereinafter, referred to as the “component (B)”). The curable composition may contain the component (A), the component (B), and a polyfunctional epoxy compound (hereinafter, referred to as the “component (C)”).

Examples of the component (A) may include particles of tungsten oxide (WO₃), zinc oxide (ZnO), silicon oxide (SiO₂), aluminum oxide (Al₂O₃), titanium oxide (TiO₂), zirconium oxide (ZrO₂), tin oxide (SnO₂), beryllium oxide (BeO), antimony oxide (Sb₂O₅), and the like, and metal oxide particles may be used singly or two or more kinds thereof may be concurrently used. In addition, it is also possible to use composite oxide particles of two or more kinds of inorganic oxides. The particle size of the inorganic oxide particles is preferably in a range of from 5 to 30 nm from the viewpoint of achieving both abrasion resistance and optical properties.

The component (B) is a silicon compound, and it may be a silicon compound having a hydrolyzable group and may be a silane coupling agent having an organic group to be bonded to a silicon atom and a hydrolyzable group.

Examples of the hydrolyzable group may include an alkoxy group, an aryloxy group, and a hydroxyl group, and the hydrolyzable group may be an alkoxy group.

The silane compound may be an organic silicon compound represented by the following general formula (I) or a hydrolysate thereof.

(R¹)ₐ(R³)_{b}Si(OR²)_{4-(a+b)} (I)

In the general formula (I) , a is 0 or 1 and b is 0 or 1, and in some embodiments a is 1 and b is 0 or 1.

R¹ represents an organic group having a functional group such as an epoxy group such as a glycidoxy group, a vinyl group, a methacryloxy group, an acryloxy group, a mercapto group, an amino group, or a phenyl group, and preferably R¹ represents an organic group having an epoxy group. The functional group may be directly bonded to a silicon atom or indirectly bonded thereto via a linking group such as an alkylene group.

R² represents, for example, a hydrogen atom, an alkyl group, an acyl group, or an aryl group, and in some embodiments R² represents an alkyl group.

The alkyl group represented by R² is, for example, a straight-chain or branched alkyl group having from 1 to 4 carbon atoms, and specific examples thereof may include a methyl group, an ethyl group, a propyl group, and a butyl group, and in some embodiments the alkyl group is a methyl group or an ethyl group.

The acyl group represented by R² is, for example, an acyl group having from 1 to 4 carbon atoms, and specific examples thereof may include an acetyl group, a propionyl group, an oleyl group, and a benzoyl group.

The aryl group represented by R² is, for example, an aryl group having from 6 to 10 carbon atoms, and specific examples thereof may include a phenyl group, a xylyl group, and a tolyl group.

R³ can be an alkyl group or an aryl group.

The alkyl group represented by R³ is, for example, a straight-chain or branched alkyl group having from 1 to 6 carbon atoms, and specific examples thereof may include a methyl group, an ethyl group, a propyl group, a butyl group, a pentyl group, and a hexyl group.

The aryl group represented by R³ is, for example, an aryl group having from 6 to 10 carbon atoms, and specific examples thereof may include a phenyl group, a xylyl group, and a tolyl group.

Specific examples of the component (B) may include
glycidoxymethyltrimethoxysilane,
glycidoxymethyltriethoxysilane,
α-glycidoxyethyltriethoxysilane,
β-glycidoxyethyltrimethoxysilane,
β-glycidoxyethyltriethoxysilane,
α-glycidoxypropyltrimethoxysilane,
α-glycidoxypropyltriethoxysilane,
β-glycidoxypropyltrimethoxysilane,
β-glycidoxypropyltriethoxysilane,
γ-glycidoxypropyltrimethoxysilane,
γ-glycidoxypropyltriethoxysilane,
γ-glycidoxypropyltripropoxysilane,
γ-glycidoxypropyltributoxysilane,
γ-glycidoxypropyltriphenoxysilane,
α-glycidoxybutyltrimethoxysilane,
α-glycidoxybutyltriethoxysilane,
β-glycidoxybutyltrimethoxysilane,
β-glycidoxybutyltriethoxysilane,
γ-glycidoxybutyltrimethoxysilane,
γ-glycidoxybutyltriethoxysilane,
δ-glycidoxybutyltrimethoxysilane,
δ-glycidoxybutyltriethoxysilane,
(3,4-epoxycyclohexyl)methyltrimethoxysilane,
(3,4-epoxycyclohexyl)methyltriethoxysilane,
β-(3,4-epoxycyclohexyl)ethyltrimethoxysilane,
β-(3,4-epoxycyclohexyl)ethyltriethoxysilane,
β-(3,4-epoxycyclohexyl)ethyltripropoxysilane,
β-(3,4-epoxycyclohexyl)ethyltributoxysilane,
β-(3,4-epoxycyclohexyl)ethyltriphenoxysilane,
γ-(3,4-epoxycyclohexyl)propyltrimethoxysilane,
γ-(3,4-epoxycyclohexyl)propyltriethoxysilane,
δ-(3,4-epoxycyclohexyl)butyltrimethoxysilane,
δ-(3,4-epoxycyclohexyl)butyltriethoxysilane,
glycidoxymethylmethyldimethoxysilane,
glycidoxymethylmethyldiethoxysilane,
α-glycidoxyethylmethyldimethoxysilane,
α-glycidoxyethylmethyldiethoxysilane,
β-glycidoxyethylmethyldimethoxysilane,
β-glycidoxyethylmethyldiethoxysilane,
α-glycidoxypropylmethyldimethoxysilane,
α-glycidoxypropylmethyldiethoxysilane,
β-glycidoxypropylmethyldimethoxysilane,
β-glycidoxypropylmethyldiethoxysilane,
γ-glycidoxypropylmethyldimethoxysilane,
γ-glycidoxypropylmethyldiethoxysilane,
γ-glycidoxypropylmethyldipropoxysilane,
γ-glycidoxypropylmethyldibutoxysilane,
γ-glycidoxypropylmethyldiphenoxysilane,
γ-glycidoxypropylethyldimethoxysilane,
γ-glycidoxypropylethyldiethoxysilane,
γ-lycidoxypropylvinyldimethoxysilane,
γ-glycidoxypropylvinyldiethoxysilane,
γ-glycidoxypropylphenyldimethoxysilane,
γ-glycidoxypropylphenyldiethoxysilane,

methyl silicate, ethyl silicate, n-propyl silicate, i-propyl silicate, n-butyl silicate, sec-butyl silicate, t-butylsilicate, tetraacetoxysilane, methyltrimethoxysilane, methyltriethoxysilane, methyltripropoxysilane, methyltriacetoxysilane, methyltributoxysilane, methyltripropoxysilane, methyltriamyloxysilane, methyltriphenoxysilane, methyltribenzyloxysilane, methyltriphenethyloxysilane, ethyltrimethoxysilane, ethyltriethoxysilane, vinyltrimethoxysilane, vinyltriacetoxysilane, vinyltrimethoxyethoxysilane, phenyltrimethoxysilane, phenyltriethoxysilane, phenyltriacetoxysilane, γ-chloropropyltrimethoxysilane, γ-chloropropyltriethoxysilane, γ-chloropropyltriacetoxysilane, 3,3,3-trifluoropropyltrimethoxysilane, γ-methacryloxypropyltrimethoxysilane, γ-mercaptopropyltrimethoxysilane, γ-mercaptopropyltriethoxysilane, β-cyanoethyltriethoxysilane, chloromethyltrimethoxysilane, chloromethyltriethoxysilane, N-(β-aminoethyl)-γ-aminopropyltrimethoxysilane, N-(β-aminoethyl)-γ-aminopropylmethyldimethoxysilane, γ-aminopropylmethyldimethoxysilane, N-(β-aminoethyl)-γ-aminopropyltriethoxysilane, N-(β-aminoethyl)-γ-aminopropylmethyldiethoxysilane, dimethyldimethoxysilane, phenylmethyldimethoxysilane, dimethyldiethoxysilane, phenylmethyldiethoxysilane, γ-chloropropylmethyldimethoxysilane, γ-chloropropylmethyldiethoxysilane, dimethyldiacetoxysilane, γ-methacryloxypropylmethyldimethoxysilane, γ-methacryloxypropylmethyldiethoxysilane, γ-mercaptopropylmethyldimethoxysilane, γ-mercaptopropylmethyldiethoxysilane, methylvinyldimethoxysilane, and methylvinyldiethoxysilane.

Examples of the commercially available silane coupling agent may include the KBM-303, KBM-402, KBM-403, KBE402, KBE403, KBM-1403, KBM-502, KBM-503, KBE-502, KBE-503, KBM-5103, KBM-602, KBM-603, KBM-903, KBE-903, KBE-9103, KBM-573, KBM-575, KBM-9659, KBE-585, KBM-802, KBM-803, KBE-846, and KBE-9007 of trade names manufactured by Shin-Etsu Chemical Co., Ltd.

The component (C) is a polyfunctional epoxy compound containing two or more epoxy groups in one molecule. It may contain two or three epoxy groups in one molecule.

Specific examples of the component (C) may include aliphatic epoxy compounds such as 1,6-hexanediol diglycidyl ether, ethylene glycol diglycidyl ether, diethylene glycol diglycidyl ether, triethylene glycol diglycidyl ether, tetraethylene glycol diglycidyl ether, nonaethylene glycol diglycidyl ether, propylene glycol diglycidyl ether, dipropylene glycol diglycidyl ether, tripropylene glycol diglycidyl ether, tetrapropylene glycol diglycidyl ether, nonapropylene glycol diglycidyl ether, neopentyl glycol diglycidyl ether, diglycidyl ether of neopentyl glycol hydroxypivalate, trimethylolpropane diglycidyl ether, trimethylolpropane triglycidyl ether, glycerol diglycidyl ether, glycerol triglycidyl ether, diglycerol diglycidyl ether, diglycerol triglycidyl ether, diglycerol tetraglycidyl ether, pentaerythritol diglycidyl ether, pentaerythritol triglycidyl ether, pentaerythritol tetraglycidyl ether, dipentaerythritol tetraglycidyl ether, sorbitol tetraglycidyl ether, diglycidyl ether of tris(2-hydroxyethyl) isocyanurate, and triglycidyl ether of tris(2-hydroxyethyl) isocyanurate, alicyclic epoxy compounds such as isophorone diol diglycidyl ether and bis-2,2-hydroxycyclohexylpropane diglycidyl ether, and aromatic epoxy compounds such as resorcinol diglycidyl ether, bisphenol A diglycidyl ether, bisphenol F diglycidyl ether, bisphenol S diglycidyl ether, orthophthalic acid diglycidyl ester, phenol novolac polyglycidyl ether, and cresol novolac polyglycidyl ether. As the component (C), a compound containing two or three epoxy groups (bifunctional or trifunctional epoxy compound) has better adhesive property with the adjacent layer or the lens substrate.

Examples of the commercially available polyfunctional epoxy compound may include the EX-201, EX-211, EX-212, EX-252, EX-313, EX-314, EX-321, EX-411, EX-421, EX-512, EX-521, EX-611, EX-612, EX-614, and EX-614B of “DENACOL” series of a trade name manufactured by Nagase ChemteX Corporation.

The curable composition can be prepared by mixing optional components such as an organic solvent, a surfactant (leveling agent), and a curing catalyst with the above components if necessary in addition to the components (A) to (C) described above.

The content of the component (A) may be 20% by mass or more, 30% by mass or more, or 40% by mass or more in the solid of the curable composition, and it may be 80% by mass or less, 70% by mass or less, or 60% by mass or less in the solid of the curable composition.

The content of the component (B) may be 5% by mass or more, 10% by mass or more, or 15% by mass or more in the solid of the curable composition, and it may be 80% by mass or less, 70% by mass or less, or 60% by mass or less in the solid of the curable composition.

The content of the component (C) may be 0% by mass or more, 10% by mass or more, or 15% by mass or more in the solid of the curable composition, and it may be 50% by mass or less, 40% by mass or less, or 30% by mass or less in the solid of the curable composition.

The filler/matrix ratio (hereinafter, also simply referred to as the “F/M ratio”) may be 0.5 or more, 0.6 or more, or 0.7 or more, and it may be 2.0 or less, 1.8 or less, or 1.5 or less.

Incidentally, the F/M ratio means the mass ratio [component (A)/(component (B)+component (C))] of the component (A) to the total mass of the component (B) and the component (C).

The curing film can be formed by coating a plastic lens substrate with the curable composition and subjecting the coated curable composition to a curing treatment (heat curing, photocuring, or the like) in accordance with the curable group. As the coating means of the curable composition, it is possible to apply a method that is usually used such as a dipping method, a spin coating method, a spray method. The curing treatment is usually conducted by heating for a curable composition containing a polyfunctional epoxy compound as the component (C). The curing treatment by heating can be conducted, for example, by placing a lens coated with the curable composition in an environment having an ambient temperature of from 50 to 150° C. for about 30 minutes to 3 hours. On the other hand, the irradiation light for the curing treatment is, for example, an electron beam or ultraviolet light for the curable composition containing the component (C) having a photocurable group as a curable group. The kind of irradiation light and the irradiation conditions are appropriately selected depending on the kind of component (C). Generally, it is possible to form a hard coat layer which has a high strength and contributes to the improvement of abrasion resistance of the lens by irradiating the curable composition with ultraviolet light at an irradiation light dose of about from 500 to 2000 mJ/cm².

(Primer Layer)

The primer layer is, for example, an aqueous resin layer formed from an aqueous resin composition containing a resin component and an aqueous solvent.

The aqueous solvent contained in the aqueous resin composition is, for example, water or a mixed solvent of water and a polar solvent or the like, and it may be water. The solid concentration in the aqueous resin composition may be from 1 to 60% by mass, from 5 to 40% by mass from the viewpoint of liquid stability and film-forming property. The aqueous resin composition can also contain additives such as an antioxidant, a dispersant, and a plasticizer if necessary in addition to the resin component. In addition, a commercially available aqueous resin composition may be used by being diluted with a solvent such as water, an alcohol, or propylene glycol monomethyl ether (PGM).

The aqueous resin composition can contain resin component in a state of being dissolved in an aqueous solvent or a state of being dispersed as fine particles (preferably colloidal particles). Among them, the aqueous resin composition is desirably a dispersion in which the resin component is dispersed in an aqueous solvent (preferably water) in the form of fine particles. In this case, the particle size of the resin component may be 0.3 μm or less from the viewpoint of dispersion stability of the composition. In addition, the pH of the aqueous resin composition may be about from 5.5 to 9.0 at 25° C. from the viewpoint of stability. The viscosity of the aqueous resin composition may be from 5 to 500 mPa·s and more preferably from 10 to 50 mPa·s at 25° C. from the viewpoint of coating suitability. In addition, an aqueous resin composition having the following film properties may be in consideration of physical properties of the aqueous resin layer to be formed. The coating film obtained by coating a glass plate with the aqueous resin composition so as to have a thickness of 1 mm and drying this for 1 hour at 120° C. has a glass transition temperature Tg of from −58° C. to 7° C., a pencil hardness of from 4 B to 2 H, and a tensile strength measured in conformity to JISK 7113 of from 15 to 69 MPa.

Examples of the resin component of the aqueous resin composition may include at least one kind selected from a polyurethane resin, an acrylic resin, or an epoxy resin, and the resin component may be a polyurethane resin. The aqueous resin composition containing a polyurethane resin, namely, an aqueous polyurethane resin composition can be prepared, for example, by subjecting a high molecular weight polyol compound and an organic polyisocyanate compound to a urethanization reaction in a solvent that is inert to the reaction and exhibits great affinity for water together with a chain extender if necessary to obtain a prepolymer, neutralizing this prepolymer, and then dispersing the prepolymer in an aqueous solvent containing a chain extender to increase the molecular weight. For such an aqueous polyurethane resin composition and the preparation method thereof, it is possible to refer to, for example, paragraphs [0009] to [0013] in JP 3588375 B1, the paragraphs [0012] to [0021] in JP 8-34897 A, paragraphs [0010] to [0033] in JP 11-92653 A, and paragraphs [0010] to [0033] in JP 11-92655A. In addition, as the aqueous polyurethane resin composition, it is also possible to use a commercially available waterborne urethane as it is or by diluting it with an aqueous solvent if necessary. As the commercially available waterborne polyurethane, for example, it is possible to use the “EVAFANOL” series manufactured by NICCA CHEMICAL CO., LTD., the “SUPERFLEX” series manufactured by DKS Co., Ltd., the “ADEKA BONTIGHTER” series manufactured by ADEKA CORPORATION, the “OLESTER” series manufactured by Mitsui Chemicals, Inc., the “VONDIC” series and “HYDRAN” series manufactured by DIC Corporation, the “IMPRANIL” series manufactured by Bayer AG, the “SOFLANATE” series manufactured by Nippon Soflan the “POIZ” series manufactured by Kao Corporation, the “SANPRENE” series manufactured by Sanyo Chemical Industries, Ltd., the “IZELAX” series manufactured by Hodogaya Chemical CO., LTD., and the “NEOREZ” series manufactured by Zeneca Group PLC.

It is possible to form an aqueous resin layer as a primer layer by coating the surface of a substrate with the aqueous resin composition and drying the aqueous resin composition.

As the coating method, a known coating method such as a dipping method or a spin coating method can be used. The coating conditions may be appropriately set so as to forma primer layer having a desired film thickness. Before coating, the polarizing film surface of the surface to be coated can also be subjected to a chemical treatment using an acid, an alkali, various kinds of organic solvents, or the like, a physical treatment using plasma, ultraviolet light, ozone, or the like, and a detergent treatment using various kinds of detergents. By conducting such a pretreatment, it is possible to improve the adhesive property.

After coating with the aqueous resin composition, an aqueous resin layer can be formed as a primer layer by drying the composition. The drying can be conducted, for example, by placing the member on which the primer layer is formed in an atmosphere of from room temperature to 100° C. for from 5 minutes to 24 hours.

(Interference Fringe Suppressing Layer)

The interference fringe suppressing layer may have an optical film thickness of from 0.2λ to 0.3λ in the light having a wavelength λ of from 450 to 650 nm in order to suppress the interference fringe. It is possible to suppress the occurrence of interference fringe by setting the optical film thickness into this range.

The interference fringe suppressing layer is obtained, for example, by coating with a dispersion containing at least metal oxide particles and a resin.

The metal oxide particles are used from the viewpoint of adjusting the refractive index of the interference fringe suppressing layer, and examples thereof may include particles of tungsten oxide (WO₃), zinc oxide (ZnO), silicon oxide (SiO₂), aluminum oxide (Al₂O₃), titanium oxide (TiO₂), zirconium oxide (ZrO₂), tin oxide (SnO₂), beryllium oxide (BeO), antimony oxide (Sb₂O₅), and the like, and the metal oxide particles may be used singly or two or more kinds thereof may be concurrently used. In addition, it is also possible to use composite oxide particles of two or more kinds of metal oxides. The particle size of the metal oxide particles is preferably in a range of from 5 to 30 nm from the viewpoint of optical properties.

Examples of the resin of the interference fringe suppressing layer may include at least one kind selected from a polyurethane resin, an acrylic resin, or an epoxy resin, and the resin may be a polyurethane resin and may be an aqueous resin composition containing a polyurethane resin, namely, an aqueous polyurethane resin composition. Examples of the aqueous polyurethane resin composition may include the resins exemplified in the primer layer.

The dispersion may contain an aqueous solvent. The aqueous solvent is, for example, water or a mixed solvent of water and a polar solvent or the like, and may be water. The solid concentration in the aqueous resin composition may be from 1 to 60% by mass and from 5 to 40% by mass from the viewpoint of liquid stability and film-forming property. The aqueous resin composition can also contain additives such as an antioxidant, a dispersant, and a plasticizer if necessary in addition to the resin component. In addition, a commercially available aqueous resin composition may be used by being diluted with a solvent such as water, an alcohol, or propylene glycol monomethyl ether (PGM).

(Antireflection Layer)

The antireflection layer may be provided on the hard coat layer. The antireflection layer, for example, has a configuration in which a low refractive index layer and a high refractive index layer are alternately disposed. The antireflection layer has preferably from 4 to 10 layers and may be from 5 to 8 layers.

The refractive index of the low refractive index layer may be from 1.35 to 1.80, and may be from 1.45 to 1.50 at a wavelength of from 500 to 550 nm. The low refractive index layer is formed of an inorganic oxide, and it may be formed of SiO₂.

The refractive index of the high refractive index layer may be from 1.90 to 2.60, and may be from 2.00 to 2.40 at a wavelength of from 500 to 550 nm.

The high refractive index layer is, for example, formed of an inorganic oxide. The inorganic oxide used in the high refractive index layer may be at least one kind of inorganic oxide selected from ZrO₂, Ta₂O₅, Y₂O₃, TiO₂, Nb₂O₅, and Al₂O₃ and ZrO₂ or Ta₂O₅.

The spectacle lens of the present disclosure may have a hard coat layer and other functional layers only on the surface of the lens substrate or on the rear surface thereof as well. The spectacle lens may be a plastic lens for spectacle of which the lens substrate is a plastic.

Above, the following embodiment is disclosed in the present specification.

[1] A spectacle lens including a lens substrate and a hard coat layer having a film thickness of 5 μm or more and 100 μm or less, in which

an indentation hardness of the hard coat layer at 30 mgf load is 25 mgf/μm² or more and 80 mgf/μm² or less.

[2] A spectacle lens including a lens substrate and a hard coat layer having a film thickness of 5 μm or more and 100 μm or less, in which

an indentation hardness of the hard coat layer at 5000 mgf load is 30 mgf/μm² or more and 80 mgf/μm² or less.

### EXAMPLES

Hereinafter, the present disclosure will be described in more detail with reference to Examples, but the present disclosure is not limited to these Examples. Incidentally, the evaluation of the plastic lenses obtained in Examples and Comparative Examples were carried out as follows.

[Average Film Thickness of Hard Coat Layer]

The average film thickness of the hard coat layer was measured by using a lens substrate on which the hard coat layer was formed and a non-contact type film thickness measuring apparatus (non-contact film thickness measuring instrument FF 8 manufactured by SystemRoad co., Ltd.) by the optical interference method.

[Indentation Hardness]

The indentation hardness of the surface of the lens substrate on which a hard coat layer was formed but before the AR layer was formed was measured at an indentation load of 30 mgf and 5000 mgf by using the Elionix hardness measuring apparatus ENT-2100.

[Test for Durability Against Hot Water]

The surface of the spectacle lens was cut by 1 cm with a cutter knife so that the cuts intersect vertically and horizontally, the spectacle lens was immersed in hot water at 80° C., and the generation of cracks was confirmed every 2 hours.

[Test for Durability in QUV]

The surface of the spectacle lens was cut by 1 cm with a cutter knife so that the cuts intersect vertically and horizontally, the spectacle lens was (1) irradiated with ultraviolet light of 0.77 W for 4 hours and then (2) put in a high-humidity environment (humidity: 90%) for 4 hours in the QUV ultraviolet fluorescent tube type accelerated weathering tester manufactured by Q-Lab Corporation. The cycle consisting of (1) and (2) was repeated for the regulated time, and the time until cracks were generated on the hard coat layer was evaluated.

[Diamond Scratch Test (DS Test)]

A diamond stylus having a tip curvature radius of 50 μm was installed to a continuous load type surface measuring machine (Type 22 manufactured by Shinto Scientific Co., ltd.), the spectacle lens and the diamond stylus were linearly relatively moved at a velocity of 10 mm/sec while gradually increasing the contact load between them at 1 g/sec to form scratches. The load was determined from the position at which the scratches started to be visually recognized under a fluorescent lamp and adopted as the “scratch generating load”, and the scratches were observed under a microscope, and the load was determined from the position at which the surface film of the spectacle lens started to be cut and adopted as the “film peeling off load”.

Incidentally, the color of the scratches to be formed is in a state indicating white as the surface film is cut. In this manner, scratches conspicuous even with a naked eye are formed when the surface film is cut.

[Abrasion Resistance Test]

The spectacle lens sample was subjected to a reciprocating wear test using the Bayer testing machine (trade name: COLTS Laboratories BTE. ABRATION TESTER) manufactured by COLTS Laboratories. This test is intended to fix the lens on one surface (convex surface) of a tray containing the regulated sands regulated by COLTS Laboratories and to wear the surface of the lens by vibrating the tray for 4 minutes at a vibration amplitude of 4 inches and 150 cycles per minute.

After the reciprocating wear test, the haze value of the plastic lens sample was measured by using a haze meter (product name: MH-150 manufactured by MURAKAMI COLOR RESEARCH LABORATORY CO., Ltd.). In addition, the plastic lens substrate on which a cured film was not formed (referred to as the standard plastic lens) was also subjected to the same test, the Bayer value was determined from the ratio of the amount of change in haze value before and after the two tests.

The Bayer value R is expressed by the following equation where ΔH1 denotes the amount of change in haze value of the plastic lens for evaluation and ΔH2 denotes the amount of change in haze value of the standard plastic lens.

R=ΔH2/ΔH1 (2)

### Example 1

The plastic lens substrate (plastic lens for spectacle, trade name: EYNOA manufactured by HOYA CORPORATION, refractive index: 1.67) was washed.

(Primer Layer)

To 305.0 g of methanol, 126 g of 4-hydroxy-4-methyl-2-pentanone (DAA) and 350.5 g of water were added, 217.5 g of a thermoplastic resin (SUPERFLEX 170 manufactured by DKS Co., Ltd.) and 1.0 g of a leveling agent (Y-7006 manufactured by Dow Corning Toray) were further added thereto, and the mixture was stirred for 24 hours at 20° C., thereby obtaining a primer liquid.

The primer liquid thus obtained was applied on the plastic lens substrate by a dipping method and dried and solidified for 20 minutes at 100° C., thereby forming a primer layer on both surfaces of the lens substrate.

(Hard Coat Layer)

The hard coat liquid prepared as presented in Table 1 was applied on the lens substrate on which the primer layer was formed by a spray method such that the thickness of the cured film to be formed became from 20 to 40 μm.

Thereafter, the hard coat liquid was pre-cured for 20 minutes at 75° C. and subsequently cured for 2 hours at 110° C., thereby fabricating a spectacle lens having a hard coat layer on both surfaces.

Through the above processes, a spectacle lens respectively having a hard coat layer on both surfaces of the lens substrate via a primer layer.

(AR Layer)

Next, the antireflection layer (AR layer) in which the layers described in the table were alternately laminated was formed on the hard coat layer by a vacuum deposition method, thereby obtaining a plastic lens. The plastic lens thus obtained was evaluated, and the results thereof are presented in the following tables.

### Examples 2 to 14, Comparative Examples 1 to 3, and Reference Example 1

The plastic lenses were obtained in the same manner as in Example 1 except that the configurations of the primer layer, the hard coat layer, and the AR layer were as those presented in the following tables. The plastic lenses thus obtained were evaluated, and the results thereof are presented in the following tables.

The reference signs in the tables are as follows.

160: plastic lens for spectacle, trade name: EYAS manufactured by HOYA CORPORATION, refractive index: 1.60

167: plastic lens for spectacle, trade name: EYNOA manufactured by HOYA CORPORATION, refractive index: 1.67

170: plastic lens for spectacle, trade name: EYRY manufactured by HOYA CORPORATION, refractive index: 1.70

TABLE 1

| | | | Exam- | Exam- | Exam- | Exam- | Exam- |
|---|---|---|---|---|---|---|---|
| | | | ple 1 | ple 2 | ple 3 | ple 4 | ple 5 |
| Kind of hard coat liquid | | | HC1 | HC2 | HC3 | HC4 | HC5 |
| Blended | Inorganic | Kind | SiO₂ | SiO₂ | SiO₂ | SiO₂ | SiO₂ |
| amount*2 | oxide | Blended | 50 | 52 | 52 | 54 | 54 |
| (parts by | particles: | amount | | | | | |
| mass) | component | | | | | | |
| | (A) | | | | | | |
| | Silane | Kind | KBM403 | KBM403 | KBM403 | KBM403 | KBM403 |
| | coupling | Blended | 30 | 29 | 24 | 23 | 18 |
| | agent: | amount | | | | | |
| | component | | | | | | |
| | (B) | | | | | | |
| | Epoxy | Kind | EX-321 | EX-321 | EX-321 | EX-321 | EX-321 |
| | compound: | Blended | 20 | 19 | 24 | 23 | 27 |
| | component | amount | | | | | |
| | (C) | | | | | | |

| | | | | | |
|---|---|---|---|---|---|
| F/M*1 | 1.0 | 1.1 | 1.1 | 1.2 | 1.2 |

| | | | Exam- | Exam- | Exam- | Exam- | Exam- |
|---|---|---|---|---|---|---|---|
| | | | ple 6 | ple 7 | ple 8 | ple 9 | ple 10 |
| Kind of hard coat liquid | | | HC6 | HC7 | HC8 | HC9 | HC10 |
| Blended | Inorganic | Kind | SiO₂ | SiO₂ | SiO₂ | SiO₂ | SiO₂ |
| amount*2 | oxide | Blended | 50 | 50 | 50 | 50 | 44 |
| (parts by | particles: | amount | | | | | |
| mass) | component | | | | | | |
| | (A) | | | | | | |
| | Silane | Kind | KBM403 | KBM403 | KBM403 | KBM403 | KBM403 |
| | coupling | Blended | 50 | 50 | 50 | 50 | 33 |
| | agent: | amount | | | | | |
| | component | | | | | | |
| | (B) | | | | | | |
| | Epoxy | Kind | — | — | — | — | EX-321 |
| | compound: | Blended | 0 | 0 | 0 | 0 | 22 |
| | component | amount | | | | | |
| | (C) | | | | | | |

| | | | | | |
|---|---|---|---|---|---|
| F/M*1 | 1.0 | 1.0 | 1.0 | 1.0 | 0.8 |

| | | | | | | | Compar- | Compar- | Compar- | Refer- |
|---|---|---|---|---|---|---|---|---|---|---|
| | | | | | | | ative | ative | ative | ence |
| | | | Exam- | Exam- | Exam- | Exam- | Exam- | Exam- | Exam- | Exam- |
| | | | ple 11 | ple 12 | ple 13 | ple 14 | ple 1 | ple 2 | ple 3 | ple 1 |
| Kind of hard coat liquid | | | HC11 | HC12 | HC13 | HC14 | HC15 | HC16 | HC17 | HC18 |
| Blended | Inorganic | Kind | SiO₂ | SnO₂ | SnO₂ | SnO₂ | SiO₂ | SiO₂ | SiO₂ | SnO₂ |
| amount*2 | oxide | Blended | 44 | 51 | 50 | 50 | 44 | 44 | 44 | 51 |
| (parts by | particles: | amount | | | | | | | | |
| mass) | component | | | | | | | | | |
| | (A) | | | | | | | | | |
| | Silane | Kind | KBM403 | KBM403 | KBM403 | KBM403 | KBM403 | KBM403 | KBM403 | KBM403 |
| | coupling | Blended | 33 | 49 | 50 | 50 | 33 | 33 | 33 | 49 |
| | agent: | amount | | | | | | | | |
| | component | | | | | | | | | |
| | (B) | | | | | | | | | |
| | Epoxy | Kind | EX-321 | — | — | — | EX-321 | EX-321 | EX-321 | — |
| | compound: | Blended | 22 | 0 | 0 | 0 | 22 | 22 | 22 | 0 |
| | component | amount | | | | | | | | |
| | (C) | | | | | | | | | |

| | | | | | | | | |
|---|---|---|---|---|---|---|---|---|
| F/M*1 | 0.8 | 1.0 | 1.0 | 1.0 | 0.8 | 0.8 | 0.8 | 1.0 |

*1filler/matrix mass ratio
*2based on solid
SiO₂: silica sol (trade name: PGM-ST manufactured by NISSAN CHEMICAL INDUSTRIES, LTD.)
KBM403: γ-glycidoxypropyltrimethoxysilane (trade name: KBM403 manufactured by Shin-Etsu Chemical Co., Ltd.)
EX-321: trimethylolpropane oil glycidyl ether (di- to tri-functional, trade name: EX-321 manufactured by Nagase ChemteX Corporation)
SnO₂: tin oxide sol (trade name: HX-405MH manufactured by NISSAN CHEMICAL INDUSTRIES, LTD.)
EX-321: trimethylolpropane oil glycidyl ether (bi- to trifunctional, trade name: EX-321 manufactured by Nagase ChemteX Corporation)

TABLE 2

| | | Exam- | Exam- | Exam- | Exam- | Exam- | Exam- | Exam- | Exam- | Exam- | Exam- |
|---|---|---|---|---|---|---|---|---|---|---|---|
| | | ple 1 | ple 2 | ple 3 | ple 4 | ple 5 | ple 6 | ple 7 | ple 8 | ple 9 | ple 10 |
| Substrate | | 167 | 167 | 167 | 167 | 167 | 167 | 167 | 167 | 167 | 160 |
| Primer | Film thickness | 1.7 | 1.7 | 1.7 | 1.7 | 1.7 | 1.6 | 1.6 | 1.6 | 1.8 | 1.8 |
| layer | (μm) | | | | | | | | | | |
| Hard | Kind of hard | HC1 | HC2 | HC3 | HC4 | HC5 | HC6 | HC7 | HC8 | HC9 | HC10 |
| coat | coat liquid | | | | | | | | | | |
| layer | Curing | 110 | 110 | 110 | 110 | 110 | 100 | 100 | 100 | 100 | 100 |
| | temperature | | | | | | | | | | |
| | (° C.) | | | | | | | | | | |
| | Curing time (h) | 1 | 1 | 1 | 1 | 1 | 2 | 2 | 2 | 2 | 2 |
| | Average film | 20 | 20 | 19 | 20 | 19 | 12 | 19 | 26 | 35 | 19 |
| | thickness (μm) | | | | | | | | | | |
| AR layer | AR film | AR1 | AR1 | AR1 | AR1 | AR1 | AR2 | AR2 | AR2 | AR2 | AR2 |
| | AR low | SiO₂ | SiO₂ | SiO₂ | SiO₂ | SiO₂ | SiO₂ | SiO₂ | SiO₂ | SiO₂ | SiO₂ |
| | refractive | | | | | | | | | | |
| | index material | | | | | | | | | | |
| | AR high | ZrO₂ | ZrO₂ | ZrO₂ | ZrO₂ | ZrO₂ | Ta₂O₅ | Ta₂O₅ | Ta₂O₅ | Ta₂O₅ | Ta₂O₅ |
| | refractive | | | | | | | | | | |
| | index material | | | | | | | | | | |
| | Number of | 8 | 8 | 8 | 8 | 8 | 8 | 8 | 8 | 8 | 8 |
| | laminated | | | | | | | | | | |
| | layers | | | | | | | | | | |

| | | | | | | Compar- | Compar- | Compar- | Refer- |
|---|---|---|---|---|---|---|---|---|---|
| | | | | | | ative | ative | ative | ence |
| | | Exam- | Exam- | Exam- | Exam- | Exam- | Exam- | Exam- | Exam- |
| | | ple 11 | ple 12 | ple 13 | ple 14 | ple 1 | ple 2 | ple 3 | ple 1 |
| Substrate | | 170 | 167 | 167 | 167 | 167 | 167 | 167 | 167 |
| Primer | Film thickness | 1.8 | *2 | *2 | *2 | 1.6 | 1.6 | 1.6 | *2 |
| layer | (μm) | | | | | | | | |
| Hard | Kind of hard | HC11 | HC12 | HC13 | HC14 | HC15 | HC16 | HC17 | HC18 |
| coat | coat liquid | | | | | | | | |
| layer | Curing | 100 | 100 | 100 | 100 | 100 | 100 | 100 | 100 |
| | temperature | | | | | | | | |
| | (° C.) | | | | | | | | |
| | Curing time (h) | 2 | 2 | 2 | 2 | 2 | 2 | 2 | 2 |
| | Average film | 23 | 7 | 10 | 14 | 19 | 26 | 37 | 4 |
| | thickness (μm) | | | | | | | | |
| AR layer | AR film | AR2 | AR1 | AR1 | AR1 | AR2 | AR2 | AR2 | AR1 |
| | AR low | SiO₂ | SiO₂ | SiO₂ | SiO₂ | SiO₂ | SiO₂ | SiO₂ | SiO₂ |
| | refractive | | | | | | | | |
| | index material | | | | | | | | |
| | AR high | Ta₂O₅ | ZrO₂ | ZrO₂ | ZrO₂ | Ta₂O₅ | Ta₂O₅ | Ta₂O₅ | ZrO₂ |
| | refractive | | | | | | | | |
| | index material | | | | | | | | |
| | Number of | 8 | 8 | 8 | 8 | 8 | 8 | 8 | 8 |
| | laminated | | | | | | | | |
| | layers | | | | | | | | |

*1 filler/matrix mass ratio
*2 without primer layer

TABLE 3

| | | Exam- | Exam- | Exam- | Exam- | Exam- | Exam- | Exam- | Exam- | Exam- | Exam- |
|---|---|---|---|---|---|---|---|---|---|---|---|
| | | ple 1 | ple 2 | ple 3 | ple 4 | ple 5 | ple 6 | ple 7 | ple 8 | ple 9 | ple 10 |
| Lens substrate | | 167 | 167 | 167 | 167 | 167 | 167 | 167 | 167 | 167 | 160 |
| Average film thickness of | | 20 | 20 | 19 | 20 | 19 | 12 | 19 | 26 | 35 | 19 |
| hard coat layer (μm) | | | | | | | | | | | |
| Indentation | IH₃₀ (mgf/μm²) | 69 | 74 | 77 | 75 | 71 | 62 | 50 | 44 | 48 | 40 |
| hardness | IH₅₀₀₀ (mgf/μm²) | 55 | 59 | 58 | 61 | 59 | 65 | 58 | 54 | 48 | 43 |
| | IH₃₀ − IH₅₀₀₀ | 14 | 15 | 19 | 14 | 13 | −3 | −8 | −10 | 0 | −3 |
| Evaluation | Test for durability | 6 hr | 6 hr | 8 hr | 6 hr | 8 hr | 1 hr | 1 hr | 1 hr | 1 hr | >20 hr |
| | against hot water | | | | | | | | | | |
| | [hr] | | | | | | | | | | |
| | Test for durability | 100 hr | 100 hr | 100 hr | 100 hr | 100 hr | 50 hr | 50 hr | 50 hr | 50 hr | >150 hr |
| | against QUV | | | | | | | | | | |
| | [hr] | | | | | | | | | | |
| | DS test (scratch | 110 | 110 | 110 | 110 | 110 | 60 | 100 | 130 | 100 | 100 |
| | generating load) | | | | | | | | | | |
| | [gf] | | | | | | | | | | |
| | DS test (film | 241 | 221 | 245 | 202 | 204 | 189 | 250 | 338 | 390 | 250 |
| | peeling off load) | | | | | | | | | | |
| | [gf] | | | | | | | | | | |
| | Bayer value (HB) | 19 | 21 | 19 | 17 | 15 | 9.5 | 9.8 | 8.3 | 7.8 | 7.5 |

| | | | | | | Compar- | Compar- | Compar- | Refer- |
|---|---|---|---|---|---|---|---|---|---|
| | | | | | | ative | ative | ative | ence |
| | | Exam- | Exam- | Exam- | Exam- | Exam- | Exam- | Exam- | Exam- |
| | | ple 11 | ple 12 | ple 13 | ple 14 | ple 1 | ple 2 | ple 3 | ple 1 |
| Lens substrate | | 170 | 167 | 167 | 167 | 167 | 167 | 167 | 167 |
| Average film thickness of | | 23 | 7 | 10 | 14 | 19 | 26 | 37 | 4 |
| hard coat layer (μm) | | | | | | | | | |
| Indentation | IH₃₀ (mgf/μm²) | 42 | 59 | 59 | 59 | 16 | 22 | 22 | 62 |
| hardness | IH₅₀₀₀ (mgf/μm²) | 42 | 38 | 38 | 38 | 23 | 27 | 26 | 34 |
| | IH₃₀ − IH₅₀₀₀ | 0 | 21 | 21 | 21 | −6 | −6 | −4 | 19 |
| Evaluation | Test for durability | 8 hr | 8 hr | 8 hr | 8 hr | — | — | — | 8 hr |
| | against hot water | | | | | | | | |
| | [hr] | | | | | | | | |
| | Test for durability | >150 hr | 150 | 150 | 150 | — | — | — | 150 |
| | against QUV | | | | | | | | |
| | [hr] | | | | | | | | |
| | DS test (scratch | 90 | 58 | 70 | 90 | 30 | 40 | 50 | 42 |
| | generating load) | | | | | | | | |
| | [gf] | | | | | | | | |
| | DS test (film | 350 | 121 | 156 | 196 | 243 | 350 | 500 | 69 |
| | peeling off load) | | | | | | | | |
| | [gf] | | | | | | | | |
| | Bayer value (HB) | 6.8 | 19.7 | 20.7 | 19.6 | 5.1 | 5.8 | 4.8 | 19.4 |

It can be seen that a high film peeling off load and excellent scratch resistance are obtained as the film thickness of the hard coat layer is in a predetermined range when the results for Examples are compared with those for Comparative Examples. Additionally, it can be seen that the spectacle lens exhibits excellent abrasion resistance from the numerical value of scratch generating load and the Bayer value as the indentation hardness at 30 mgf load is in a predetermined range.

In addition, from the above results, it can be seen that a spectacle lens which exhibits excellent crack resistance while exhibiting excellent scratch resistance and excellent abrasion resistance is obtained as the value of IH₃₀−IH₅₀₀₀ is a predetermined positive value or more.

1. A spectacle lens comprising:
a lens substrate; and
a hard coat layer having a film thickness of 5 μm or more and 100 μm or less, wherein
an indentation hardness of the hard coat layer at 30 mgf load is 25 mgf/μm² or more and 100 mgf/μm² or less.

2. The spectacle lens according to claim 1, wherein a film thickness of the hard coat layer is 7 μm or more and 100 μm or less.

3. The spectacle lens according to claim 2, wherein an indentation hardness of the hard coat layer at 5000 mgf load is 30 mgf/μm² or more and 100 mgf/μm² or less.

4. The spectacle lens according to claim 3, wherein a difference (IH₃₀−IH₅₀₀₀) between an indentation hardness IH₅₀₀₀ at 5000 mgf load and an indentation hardness IH₃₀ at 30 mgf load of the hard coat layer is 3 mgf/μm² or more.

5. The spectacle lens according to claim 4, wherein the hard coat layer is obtained by curing a curable composition containing inorganic oxide particles and a silicon compound having a hydrolyzable group.

6. The spectacle lens according to claim 5, wherein the curable composition further contains a polyfunctional epoxy compound.

7. The spectacle lens according to claim 6, further comprising a primer layer between the lens substrate and the hard coat layer.

8. The spectacle lens according to claim 7, further comprising an interference fringe suppressing layer between the lens substrate and the hard coat layer.

9. The spectacle lens according to claim 8, further comprising an antireflection layer on the hard coat layer.

10. The spectacle lens according to claim 1, wherein an indentation hardness of the hard coat layer at 5000 mgf load is 30 mgf/μm² or more and 100 mgf/μm² or less.

11. The spectacle lens according to claim 1, wherein a difference (IH₃₀−IH₅₀₀₀) between an indentation hardness IH₅₀₀₀ at 5000 mgf load and an indentation hardness IH₃₀ at 30 mgf load of the hard coat layer is 3 mgf/μm² or more.

12. The spectacle lens according to claim 2, wherein a difference (IH₃₀−IH₅₀₀₀) between an indentation hardness IH₅₀₀₀ at 5000 mgf load and an indentation hardness IH₃₀ at 30 mgf load of the hard coat layer is 3 mgf/μm² or more.

13. The spectacle lens according to-claim 1, wherein the hard coat layer is obtained by curing a curable composition containing inorganic oxide particles and a silicon compound having a hydrolyzable group.

14. The spectacle lens according to-claim 2, wherein the hard coat layer is obtained by curing a curable composition containing inorganic oxide particles and a silicon compound having a hydrolyzable group.

15. The spectacle lens according claim 1, further comprising a primer layer between the lens substrate and the hard coat layer.

16. The spectacle lens according to claim 1, further comprising an interference fringe suppressing layer between the lens substrate and the hard coat layer.

17. The spectacle lens according claim 1, further comprising an antireflection layer on the hard coat layer.

18. A spectacle lens comprising:
a lens substrate; and
a hard coat layer having a film thickness of 7 μm or more and 80 μm or less, wherein
an indentation hardness of the hard coat layer at 30 mgf load is 25 mgf/μm² or more and 100 mgf/μm² or less.

19. A spectacle lens comprising:
a lens substrate; and
a hard coat layer having a film thickness of 18 μm or more and 40 μm or less, wherein
an indentation hardness of the hard coat layer at 30 mgf load is 25 mgf/μm² or more and 100 mgf/μm² or less.
